(19) United States
(12) Patent Application Publication
(10) Pub. No.: US 2005/0052028 A1
(43) Pub. Date: Mar. 10, 2005

(54) Hydraulic power generation system based on water pumping by weight of water

(76) Inventor: Kud-Chu Chiang, Hsinchu City (TW)

Correspondence Address: RABIN & Berdo, PC, 1101 14TH STREET, NW, SUITE 500, WASHINGTON, DC, 20005, US

(21) Appl. No.: 10/891,183

(22) Filed: Jul. 15, 2004

(30) Foreign Application Priority Data
Sep. 5, 2003 (TW) 092124600

(51) Int. Cl. H02P 9/04

(52) U.S. Cl. 290/1 R

(57) ABSTRACT

A hydraulic power generation system employs a plurality of buckets carried by an endless chain to receive water falling from height and drive the chain, which in turn drives a water pumping device to raise water to the height for automatic and continuous generation of power.

### BACKGROUND OF THE INVENTION

1. Field of the Invention

The present invention relates to the field of hydraulic power generation, and in particular to a hydraulic power generation that employs a plurality of buckets carried by an endless chain to receive water falling from height and drive the chain, which in turn drives a water pumping device to raise water to the height for automatic and continuous generation of power

2. Description of Related Art

As the natural power source is dying out, people are seeking alternative power to substitute fossil energy that plays the most important role of energy supply for the modern society. Solar energy, hydraulic energy, and even wind energy are the most promising solution for the time being. However, the solar energy is only available in areas having regular and intense sun light and can only be collected in day times. In addition, solar panels may occupy a great space and is thus not space efficient. The wind power generation is also available in limited areas around the world, for it needs constant and strong winds to drive the power generator, otherwise wind power generation would be economically inefficient. Tidal power generation requires facility occupying a long section of costal line, as well as a large difference in height between high and low tides. In addition, due to the elapse of time to change from high tide to low tide, the tidal power generation is also very time inefficient. Conclusively, those promising alternatives for energy supply all have inherent limitations and drawbacks.

To overcome the shortcomings, the present invention intends to provide an improved hydraulic power generation system to mitigate the aforementioned problems.

### SUMMARY OF THE INVENTION

A primary objective of the present invention is to provide a fully automatic hydraulic power generation system, which employs the weight of water as driving force to continuously drive power generator whereby power can be automatically generated without any engine to drive the generator.

In order to accomplish the aforementioned objective, the hydraulic power generation system in accordance with the present invention comprises a driving wheel and an auxiliary wheel with an endless transmission chain surrounds and extends between the driving wheel and the auxiliary wheel. The auxiliary wheel is also coupled to a pulley by means of a second chain mating toothed wheels respectively mounted to the auxiliary wheel and the pulley. The pulley engages a belt that drives a power generator. Alternatively, the pulley may be directly coupled to the power generator by means of for example teeth. The transmission chain carries a plurality of buckets, which are arranged on opposite sides of the driving wheel and the auxiliary wheel. The driving wheel is coupled to a water pumping cylinder by link and crank arm, of which a front end extends into the water pumping cylinder forming a water pumping piston one-way valve. The water pumping cylinder has a water discharge pipe connected to a water dispensing tank in which flow control switch is arranged.

The design feature of the present invention is described as follows:

(1) The pipe employed in the present invention is the one that has an inside diameter of 4 centimeters and a length (height) of 10 meters. Thus, approximately 15 Kg of water in total is contained in the pipes of the power generation system of the present invention. The capacity of each bucket is selected to 15 kgs. When the system is in operation, there are eight buckets in each side and the eight buckets of one side are filled with water to serve as driving buckets. Among the eight driving buckets, the first and second buckets provide energy to overcome mechanical friction inherent in the system, the third bucket serves to counterbalance the weight of the water in the pipes, the fourth bucket provides power to pump water, and the remaining fifth, sixth, seventh, and eighth buckets provide power to drive the power generator, thereby forming an effective, water-circulated power generation system.

(2) The driving wheel is set to drive an amount of water, equivalent to that can be carried by four buckets, that is 60 kgs. Thus, each turn of the driving wheel drives each of four water pumping cylinders to operate one complete cycle, which pumps an amount of 15 kg water, that is 60 kgs in total for four cylinders for completely filling up four of the buckets on the transmission chain.

(3) The system of the present invention is initiated by manually rotating the driving wheel, which drives the piston to draw water into the water pumping cylinder to fill the four driving buckets with manual adjustment of flow control switch. Thus, by manually rotating the driving wheel two turns, the eight driving buckets can be filled up with water, which in turn automatically drives the whole system to continuously generate power. Thus, the present invention can be employed in both large-sized and small-sized power generation system.

(4) Further, the operation of the system of the present invention can be maintained by the circulation of water. Thus, the operation is simple and easy.

Other objects, advantages, and novel features of the invention will become more apparent from the following detailed description when taken in conjunction with the accompanying drawings, in which:

### BRIEF DESCRIPTION OF THE DRAWINGS

FIG. 1 is a schematic view of a hydraulic power generation system constructed in accordance with the present invention;

FIG. 2 is a schematic cross-sectional view showing a water pumping device of the hydraulic power generation system in accordance with the present invention; and

FIG. 3 is a schematic view showing a different embodiment of the water pumping device of the hydraulic power generation system in accordance with the present invention.

### DETAILED DESCRIPTION OF PREFERRED EMBODIMENTS

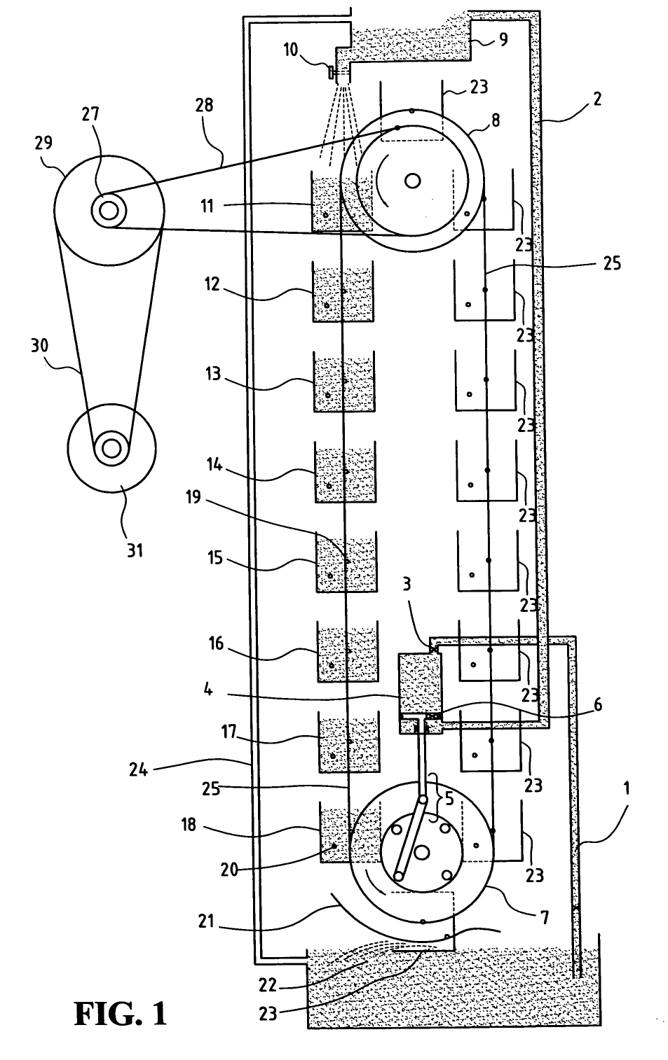

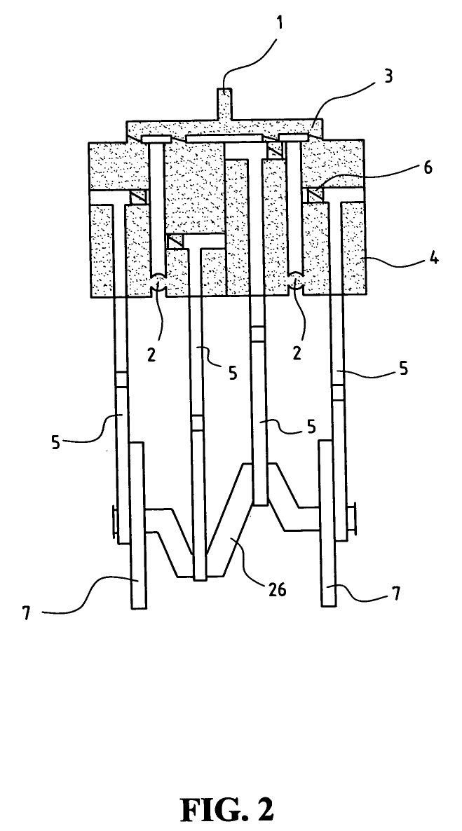

With reference to FIGS. 1 and 2, which shows an embodiment of a hydraulic power generation system constructed in accordance with the present invention, the hydraulic power generation system comprises a water intake pipe 1, a water discharge pipe 2, a one-way valve 3, water pumping cylinders 4, a set of link and crank arm 5, a water pumping piston one-way valve 6, a driving wheel 7, an auxiliary wheel 8, a water dispensing tank 9, a flow control switch 10, a plurality of driving buckets 11-18, a plurality of bucket shafts 19, a plurality of guiding rods 20, a guiding track 21, a water reservoir 22, a plurality of empty buckets 23, an overflow drainage pipe 24, a transmission chain 25, a crankshaft 26, toothed wheels 27, a chain 28, an accelerating pulley 29, a belt 30 and a generator 31.

To couple the present invention with the water pumping cylinders, the transmission chain 25 is arranged between the driving wheel 7 and the auxiliary wheel 8, both being symmetric between left and right sides. The left-right-symmetric driving wheel 7 is mechanically coupled to four water pumping cylinders 4 by the crankshaft 26 and four sets of link and crank arm 5. The toothed wheels 27 are mounted to the auxiliary wheel 8 and the pulley 29 and are connected to each other by the chain 28. A belt 30 is arranged between the pulley 29 and the generator 31. The transmission chain 25 carries the plurality of buckets, which are arranged to correspond to each other on opposite sides. In other words, eight driving buckets 11-18 are arranged on one side and eight empty buckets 23 are arranged on the other side. An additional empty bucket 23 is arranged on and below the driving wheel 7 and the auxiliary wheel 8. Thus, there are eighteen buckets in total. Each bucket is provided with a bucket shaft 19 to maintain the bucket in the proper course. Each bucket is also provided with a guiding rod 20 engageable with the guiding track 21 located below the driving wheel 7 to allow the bucket to automatically pour the water that it carries into the water reservoir 22.

A front end of each set of link and crank arm 5 extends into each corresponding water pumping cylinder 4 and forms a water pumping piston one-way valve 6. The water intake pipe 1 is connected to the water pumping cylinders 4 by a one-way valve 3, which serves as a check valve to prevent reverse flow of water. The water discharge pipe 2 that extends from the water pumping cylinders 4 has a remote end connected to the water dispensing tank 9. The water dispensing tank 9 is provided with a flow control switch 10 and is also connected to an overflow drainage pipe 24 that extends downwards to the water reservoir 22.

The operation of the present invention will be briefly described as follows: Initially, the driving wheel 7 is manually rotated, which, by means of the crankshaft 26 coupled to the driving wheel 7, drives the water pumping cylinders 4 to pump water. Water is drawn into the water pumping cylinders 4 via the one-way valve 3 and is pumped by the water pumping piston one-way valve 6 to the water dispensing tank 9. Water is then dispensed from the water dispensing tank 9 to the driving buckets and once the driving buckets are filled up with water, the weight of the water contained in the driving buckets is converted into power for driving the rotation of the driving wheel 7 and the auxiliary wheel 8. The auxiliary wheel 8 then moves the pulley 29, which in turn drives the generator 31. Thus, power generation is continuously and cyclically performed.

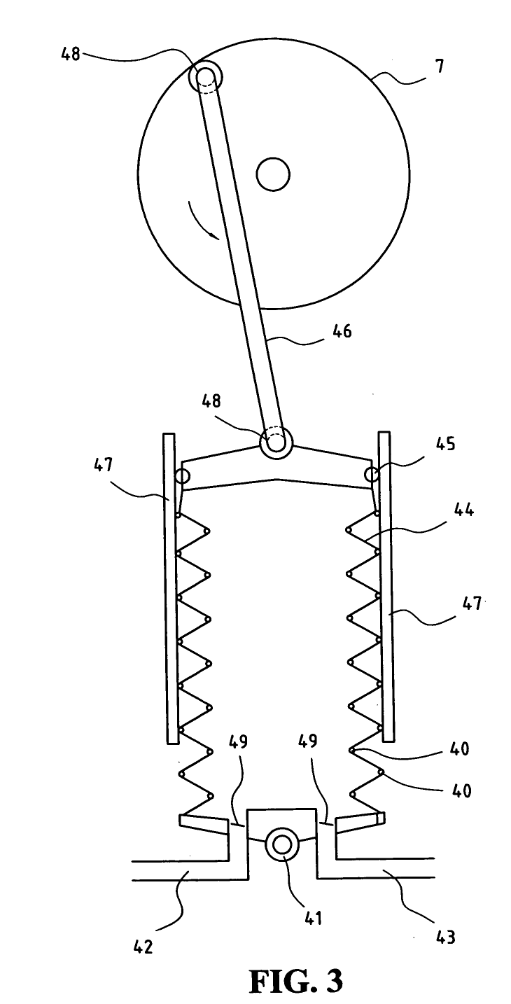

Also referring to FIG. 3, which shows a different embodiment of the water pumping cylinder cooperating with the present invention, the water pumping cylinder is comprised of steel rings 40, a fixed axle 41, a water outlet 42, a water inlet 43, a rubber bellow 44, rollers 45, a crank arm 46, guiding tracks 47, moving axles 48, and a one-way valve 49.

The water pumping cylinder is constructed by having opposite ends of the crank arm 46 respectively pivoted to the moving axles 48 to connect the driving wheel 7 to the rubber bellow 44. The rollers 45 are arranged on opposite sides of the rubber bellow 44 and are guided by the guiding tracks 47. The steel rings 40 are arranged at folding sections of the rubber bellow. An end of the rubber bellow 44 is connected to the outlet 42 and the inlet 43 by the fixed axle 41 and a one-way valve 49 is arranged in each of the outlet 42 and the inlet 43. Thus, by up-and-down movement of the rubber bellow 44, water is drawn into and then pumped out of the bellow 44. This design eliminates the adverse effect of sand and earth residual inside the bellow 44.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A hydraulic power generation system comprising:
a driving wheel, which is symmetric in left and right sides;
an auxiliary wheel, which is symmetric in left and right sides and is provided with a toothed wheel;
a transmission chain mounted between the driving wheel and the auxiliary wheel and carrying a plurality of buckets that are opposite to each other;
a water pumping cylinder having a water intake pipe and a water discharge pipe, a one-way valve arranged in a connection between the water intake pipe and the water pumping cylinder;
a water dispensing tank in communication with the water pumping cylinder via the water discharge pipe and having a flow control switch;
a set of link and crank arm having a front end extending into the water pumping cylinder and forming a water pumping piston on which a water pumping piston one-way valve is formed;
a pulley to which a toothed wheel is mounted;
a chain mounted between the auxiliary wheel and the toothed wheel of the pulley; and
a generator coupled to the pulley by a belt.

2. The hydraulic power generation system as claimed in claim 1, wherein a water reservoir is provided below the driving wheel and communicates with the water dispensing by an overflow drainage pipe.

3. The hydraulic power generation system as claimed in claim 1, wherein the transmission chair carries a plurality of buckets.

4. The hydraulic power generation system as claimed in claim 1, the system comprises four water pumping cylinder each associated with one set of link and crank arm that cooperates with a crankshaft to couple the driving wheel to the water pumping cylinders.

5. The hydraulic power generation system as claimed in claim 1, wherein the water pumping cylinder comprises a rubber bellow that is coupled to the driving wheel by a crank arm having opposite ends pivoted by movable axles to the driving wheel and the water pumping cylinder.

6. The hydraulic power generation system as claimed in claim 5 further comprising rollers arranged on opposite sides of the rubber bellow and engaging guiding tracks of the water pumping cylinder.

7. The hydraulic power generation system as claimed in claim 5, wherein the rubber bellow comprises a plurality of folding sections in each of which a steel ring is arranged.

8. The hydraulic power generation system as claimed in claim 5, wherein the rubber bellow is mounted to water inlet and water outlet each comprising a one-way valve by a fixed axle.
